(19) United States
(12) Patent Application Publication
(10) Pub. No.: US 2025/0227676 A1
(43) Pub. Date: Jul. 10, 2025

(54) METHOD AND APPARATUS FOR SUBBAND UTILIZATION IN FULL DUPLEX SYSTEM

(71) Applicant: Lenovo (Beijing) Limited, Beijing (CN)

(72) Inventors: Yuantao Zhang, Beijing (CN); Ruixiang Ma, Beijing (CN); Hongmei Liu, Beijing (CN); Zhi Yan, Beijing (CN); Haiming Wang, Beijing (CN)

(73) Assignee: Lenovo (Beijing) Limited, Beijing (CN)

(21) Appl. No.: 18/853,907

(22) PCT Filed: Apr. 8, 2022
(86) PCT No.: PCT/CN2022/085794

§ 371 Date: Oct. 3, 2024

(51) Int. Cl. H04W 72/0453; H04L 5/00

(52) U.S. Cl. CPC H04W 72/0453; H04L 5/0044; H04L 5/0055

(57) ABSTRACT

The present application relates to a method and an apparatus for subband utilization in full duplex system. The method includes: determining, by a UE, at least one subband, wherein the at least one subband is associated with a first BWP; and transmitting, by the UE, an uplink signal in the at least one subband in a first set of time domain resources.

### TECHNICAL FIELD

Embodiments of the present application generally relate to wireless communication technology, especially to a method and an apparatus for subband utilization in full duplex system under 3GPP (3rd Generation Partnership Project) 5G new radio (NR).

### BACKGROUND

To improve data communication and throughput and reduce transmission latency, full duplex operation could be deployed by a base station (BS), which means the BS has the capability of simultaneous transmission and reception on a same carrier. The BS can utilize a configuration indicating a set of time domain resource(s) and utilize another configuration(s) indicating different transmission direction(s) for the time domain resource(s) for different UE(s). Therefore, different UEs might have different transmission directions in these time domain resource(s), and the BS needs to transmit and receive simultaneously in these time domain resource(s).

Further, full duplex can be deployed in a conventional time division duplex (TDD) system, where a UE configured with a downlink (DL) bandwidth part (BWP) and an uplink (UL) BWP with the same BWP identification (ID) should be center frequency aligned so that radio frequency (RF) retuning is not needed when the transmission direction switches from DL transmission to UL transmission and vice versa. However, such requirements in TDD system may impact subband configuration and determination for full duplex operation in BS side.

### SUMMARY

Some embodiments of the present application provide a user equipment (UE). The UE includes a processor and a transceiver electrically coupled to the processor. The processor is configured to: determine at least one subband, wherein the at least one subband is associated with a first bandwidth part (BWP); and transmit, via the transceiver, an uplink signal in the at least one subband in a first set of time domain resources.

Some embodiments of the present application provide a method of a UE. The method includes: determining, by the UE, at least one subband, wherein the at least one subband is associated with a first BWP; and transmitting, by the UE, an uplink signal in the at least one subband in a first set of time domain resources.

Some embodiments of the present application provide a base station (BS). The BS includes a processor and a transceiver electrically coupled to the processor. The processor is configured to: receive, via the transceiver, an uplink signal from a UE in at least one subband in a first set of time domain resources, wherein the at least one subband is associated with a first BWP; and receive, via the transceiver, another uplink signal from the UE in the first BWP in a second set of time domain resources.

The details of one or more examples are set forth in the accompanying drawings and the description below. Other features, objects, and advantages will be apparent from the description and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2A illustrates a schematic diagram of message transmission in accordance with some embodiments of the present application.

FIG. 2B illustrates a schematic diagram of time domain resources in accordance with some embodiments of the present application.

FIG. 3A illustrate a schematic diagram of an association between the at least one subband and the first BWP in accordance with some embodiments of the present application.

FIG. 3B illustrate a schematic diagram of an association between the at least one subband and the first BWP in accordance with some embodiments of the present application.

FIG. 3C illustrate a schematic diagram of an association between the at least one subband and the first BWP in accordance with some embodiments of the present application.

FIG. 3D illustrate a schematic diagram of an association between the at least one subband and the first BWP in accordance with some embodiments of the present application.

FIG. 4A illustrate a schematic diagram of an association between the at least one subband and the first BWP in accordance with some embodiments of the present application.

FIG. 4B illustrate a schematic diagram of an association between the at least one subband and the first BWP in accordance with some embodiments of the present application.

FIG. 4C illustrate a schematic diagram of an association between the at least one subband and the first BWP in accordance with some embodiments of the present application.

FIG. 5 illustrates a schematic diagram of message transmission in accordance with some embodiments of the present application.

FIGS. 6A and 6B illustrate flow charts of a method for wireless communications according to an embodiment of the present disclosure.

FIG. 7 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. Embodiments of the present application may be provided in a network architecture that adopts various service scenarios, for example but is not limited to, 3GPP 3G, long-term evolution (LTE), LTE-Advanced (LTE-A), 3GPP 4G, 3GPP 5G NR (new radio), etc. It is contemplated that along with the 3GPP and related communication technology development, the terminologies recited in the present application may change, which should not affect the principle of the present application.

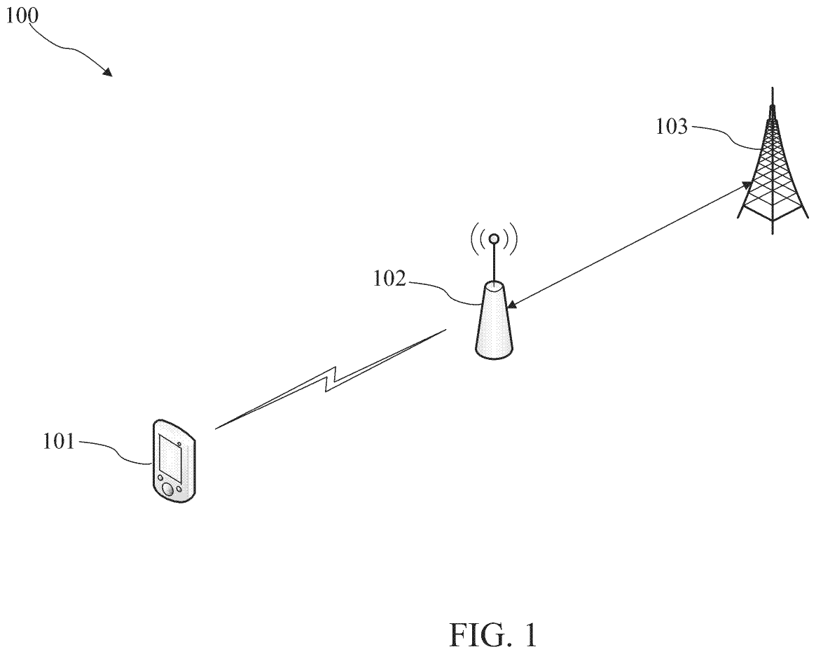

Referring to FIG. 1, a wireless communication system 100 may include a user equipment (UE) 101, a base station (BS) 102 and a core network (CN) 103. Although a specific number of the UE 101, the BS 102 and the CN 103 are depicted in FIG. 1, it is contemplated that any number of the UEs 101, the BSs 102 and the CNs 103 may be included in the wireless communication system 100.

The CN 103 may include a core Access and Mobility management Function (AMF) entity. The BS 102, which may communicate with the CN 103, may operate or work under the control of the AMF entity. The CN 103 may further include a User Plane Function (UPF) entity, which communicatively coupled with the AMF entity.

The BS 102 may be distributed over a geographic region. In certain embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

The UE 101 may include, for example, but is not limited to, computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), Internet of Thing (IoT) devices, or the like.

According to some embodiments of the present application, the UE 101 may include, for example, but is not limited to, a portable wireless communication device, a smart phone, a cellular telephone, a flip phone, a device having a subscriber identity module, a personal computer, a selective call receiver, a wireless sensor, a monitoring device, or any other device that is capable of sending and receiving communication signals on a wireless network.

In some embodiments of the present application, the UE 101 may include, for example, but is not limited to, wearable devices, such as smart watches, fitness bands, optical head-mounted displays, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE 101 may communicate directly with the BS 102 via uplink communication signals.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, a Long Term Evolution (LTE) network, a 3GPP-based network, a 3GPP 5G network, a satellite communications network, a high altitude platform network, and/or other communications networks.

In some embodiments of the present application, the wireless communication system 100 is compatible with the 5G New Radio (NR) of the 3GPP protocol or the 5G NR-light (or reduced capability NR UEs) of the 3GPP protocol, wherein the BS 102 transmits data using an OFDM modulation scheme on the downlink (DL) and the UE 101 transmits data on the uplink (UL) using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, the UE 101 and BS 102 may communicate using other communication protocols, such as the IEEE 802.11 family of wireless communication protocols. Further, in some embodiments of the present application, the UE 101 and BS 102 may communicate over licensed spectrums, whereas in other embodiments, the UE 101 and the BS 102 may communicate over unlicensed spectrums. The present application is not intended to be limited to the implementation of any particular wireless communication system architecture or protocol. In yet some embodiments of present application, the BS 102 may communicate with the UE 101 using the 3GPP 5G protocols.

To improve data communication and throughput and reduce transmission latency, full duplex operation is supported by the BS 102, which means the BS 102 has the capability of simultaneous transmission and reception on a same carrier. For a conventional time division duplex (TDD) system where the BS supports full duplex, the BS 102 may utilize one configuration indicating a set of time domain resource(s) (e.g., slot(s) or symbol(s)) and another configuration(s) to indicate different transmission direction(s) for the time domain resource(s) for different UE(s). Therefore, different UEs might have different transmission directions in these time domain resource(s), and the BS 102 needs to transmit and receive simultaneously in these time domain resource(s). Full duplex is then performed in such time domain resources in BS side.

Further, in TDD system, the UL and DL transmission happens in a UL bandwidth part (BWP) and a DL BWP respectively. The UE may be provided with a set of paired DL BWPs and UL BWPs, among which one pair of DL BWP and UL BWP are active BWPs. A paired DL BWP and the UL BWP are configured with the same BWP identification (ID) and they should be center frequency aligned so that radio frequency (RF) retuning is not needed when the transmission direction switches from DL transmission to UL transmission and vice versa. This may be beneficial for power saving at UE side and reducing time gap for switching the transmission direction. However, such requirements in TDD system may impact the configuration and determination of subband for full duplex.

Specifically, in TDD system, when the time domain resource(s) for full duplex is indicated, there are two specific time domain resources including one time domain resource for UL transmission within a subband and one time domain resource for UL transmission within an active BWP. It is not desired to perform RF retuning between the two specific time domain resources. In addition, it is desired that the overhead for subband configuration should be as lower as possible.

Accordingly, in the present disclosure, new subband configuration and determination are introduced for the UE 101 and the BS 102 under full duplex in TDD system. That is, UE 101 has the knowledge of BS side full duplex operation. In some embodiments, such knowledge may be obtained from a configuration indicating that full duplex is supported by the BS 102, or obtained implicitly when the subband configuration is provided by the BS 102. More details on embodiments of the present disclosure will be further described hereinafter.

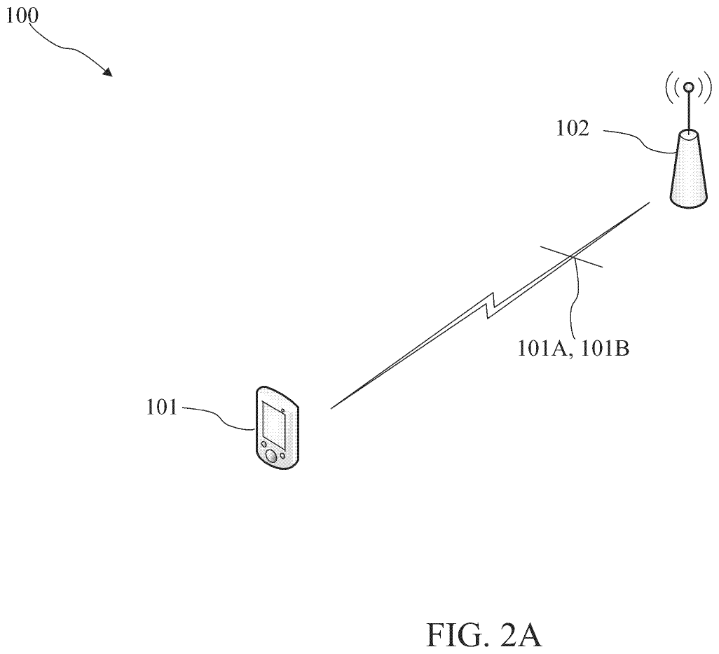

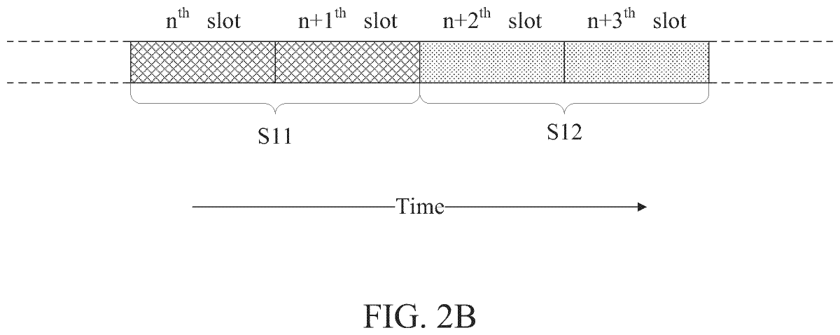

Refer to FIGS. 2A and 2B. FIG. 2A is a schematic diagram of message transmission in accordance with some embodiments of the present application. FIG. 2B illustrates a schematic diagram of time domain resources in accordance with some embodiments of the present application. In some embodiments, the BS 102 may determine at least one subband to be associated with a first BWP, and the UE 101 may determine the at least one same subband which is associated with the first BWP.

Accordingly, the UE 101 may transmit an UL signal 101A (if scheduled) to the BS 102 in the at least one subband in a first set S11 of time domain resources (i.e., slots in FIG. 2B) while the first set S11 of time domain resources was supposed to be use for transmission of DL signal (i.e., for UEs not having the knowledge BS side full duplex, the first set S11 of time domain resources is used for transmitting DL signal). The BS 102 may receive the UL signal 101A from the UE 101 in the at least one subband in the first set S11 of time domain resources. Then, the UE 101 may transmit an UL signal 101B (if scheduled) in the first BWP in a second set S12 of time domain resources (i.e., slots in FIG. 2B). The BS 102 may receive the UL signal 101B from the UE 101 in the first BWP in the second set S12 of time domain resources.

Based on the association between the at least one subband and the first BWP, RF retuning is not needed between the slots of the first set S11 and the slots of the second set S12. The UE 101 could camp on the first BWP in both the first set S11 of time domain resources and the second set S12 of time domain resources. However, the frequency domain resources for data transmission are different for different set of time domain resources. It should be noted that, in the present disclosure, time domain resources of the first set S11 and the second set S12 may be slots. However, it is not intended to limit the type of the time domain resources which may include slots or symbols.

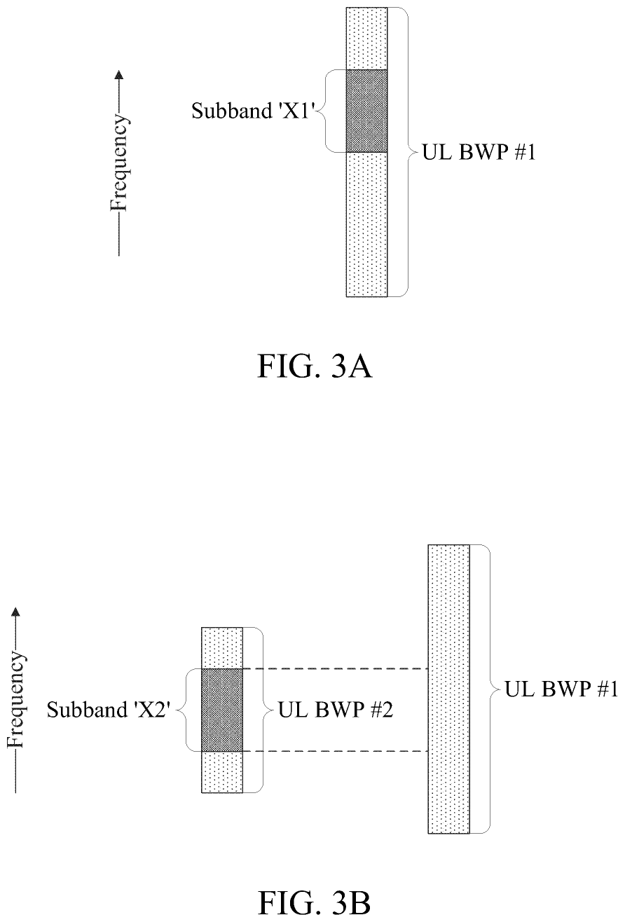

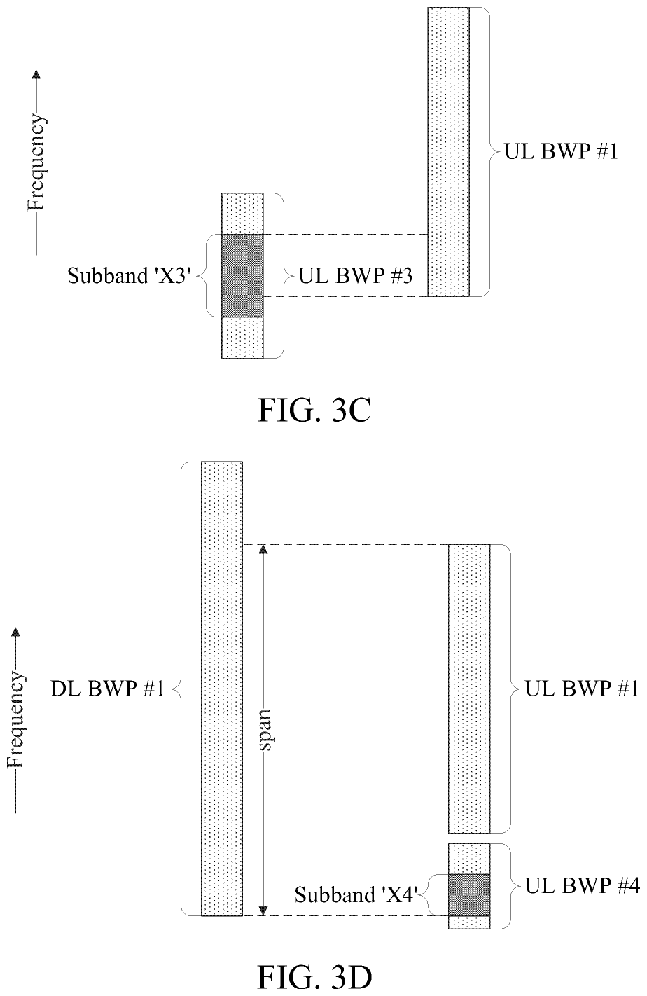

FIG. 3A illustrates a schematic diagram of an association between the at least one subband and the first BWP. In some embodiments, the at least one subband may include a subband ‘X1’. The first BWP may be an UL BWP #1. When the subband ‘X1’ is configured in a configuration of the UL BWP #1, the subband ‘X1’ is associated with the UL BWP #1.

FIG. 3B illustrates a schematic diagram of an association between the at least one subband and the first BWP. In some embodiments, the at least one subband may include a subband ‘X2’. The first BWP may be the UL BWP #1. When the subband ‘X2’ is configured in a configuration of an UL BWP #2 and the subband ‘X2’ is fully within the bandwidth of the UL BWP #1, the subband ‘X2’ is associated with the UL BWP #1.

FIG. 3C illustrates a schematic diagram of an association between the at least one subband and the first BWP. In some embodiments, the at least one subband may include a subband ‘X3’. The first BWP may be the UL BWP #1. When the subband ‘X3’ is configured in a configuration of an UL BWP #3 and the subband ‘X3’ is partially within the bandwidth of the UL BWP #1, the subband ‘X3’ is associated with the UL BWP #1.

It should be noted that, in some scenarios, it may be pre-configured to the UE 101 and the BS 102 that the subband ‘X3’ is associated with the UL BWP #1 when the subband ‘X3’ is partially within the bandwidth of the UL BWP #1. Alternatively, in some scenarios with different network requirements, it may be pre-configured to the UE 101 and the BS 102 that the subband ‘X3’ is not associated with the UL BWP #1 when the subband ‘X3’ is partially within the bandwidth of the UL BWP #1.

FIG. 3D illustrates a schematic diagram of an association between the at least one subband and the first BWP. In some embodiments, the at least one subband may include a subband ‘X4’. The first BWP may be the UL BWP #1. When the subband ‘X4’ is configured in a configuration of an UL BWP #4 and a span of the subband ‘X4’ and the UL BWP #1 is within the bandwidth of a DL BWP #1 (which has the same BWP ID as the UL BWP #1), the subband ‘X4’ is associated with the UL BWP #1.

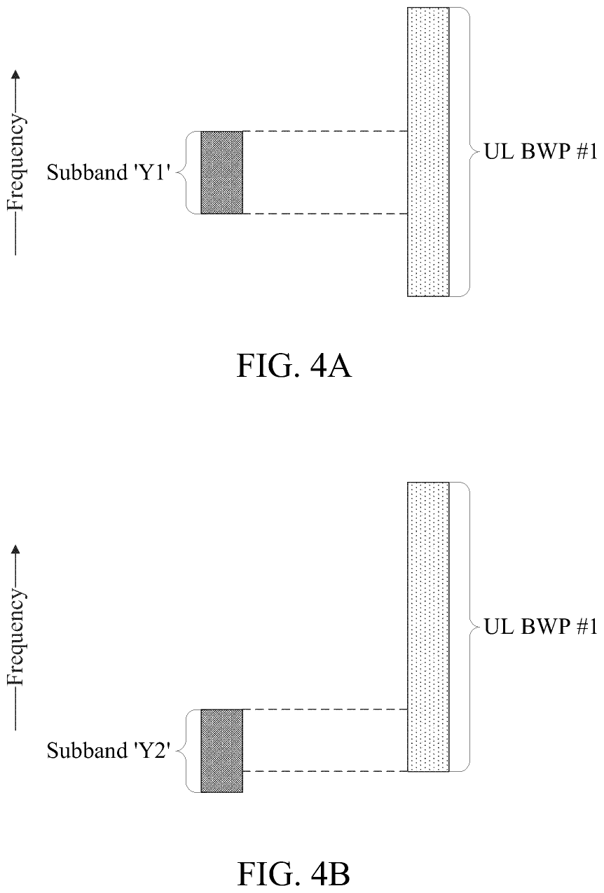

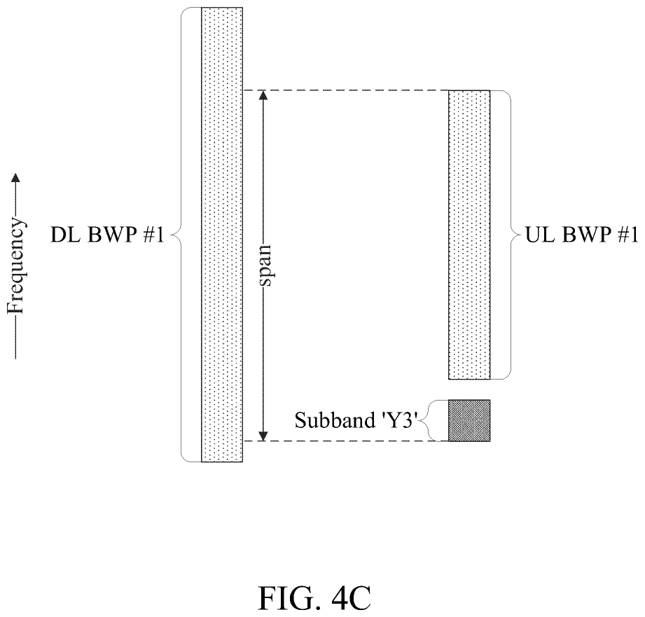

FIG. 4A illustrates a schematic diagram of an association between the at least one subband and the first BWP. In some embodiments, the at least one subband may include a subband ‘Y1’. The first BWP may be the UL BWP #1. The subband ‘Y1’ is configured separately from the configuration of the UL BWP #1 and the subband ‘Y1’ is fully within the bandwidth of the UL BWP #1, then the subband ‘Y1’ is associated with the UL BWP #1.

FIG. 4B illustrates a schematic diagram of an association between the at least one subband and the first BWP. In some embodiments, the at least one subband may include a subband ‘Y2’. The first BWP may be the UL BWP #1. The subband ‘Y2’ is configured separately from the configuration of the UL BWP #1 and the subband ‘Y2’ is partially within the bandwidth of the UL BWP #1, then the subband ‘Y2’ is associated with the UL BWP #1.

It should be noted that, in some scenarios, it may be pre-configured to the UE 101 and the BS 102 that the subband ‘Y2’ is associated with the UL BWP #1 when the subband ‘Y2’ is partially within the bandwidth of the UL BWP #1. Alternatively, in some scenarios with different network requirements, it may be pre-configured to the UE 101 and the BS 102 that the subband ‘Y2’ is not associated with the UL BWP #1 when the subband ‘Y2’ is partially within the bandwidth of the UL BWP #1.

FIG. 4C illustrates a schematic diagram of an association between the at least one subband and the first BWP. In some embodiments, the at least one subband may include a subband ‘Y3’. The first BWP may be the UL BWP #1. A span of the subband ‘Y3’ and the UL BWP #1 is within the bandwidth of the DL BWP #1 (which has the same BWP ID as the UL BWP #1), then the subband ‘Y3’ is associated with the UL BWP #1.

In some embodiments, the at least one subband is associated with the first BWP when a numerology (e.g., sub carrier spacing (SCS) of ‘m’ kHz) of the at least one subband is the same as a numerology (e.g., SCS of ‘m’ kHz) of the first BWP.

In some embodiments, based on the associations between the at least one subband and the first BWP above, there may be single subband that can be associated with the first BWP (i.e., only one subband can be associated with the first BWP). In some cases, the BS 102 may transmit the configuration of the first BWP to the UE 101 and the single subband may be configured in the configuration of the first BWP. In some cases, when no subband is configured in the configuration of the first BWP, the single subband fulfilling the above requirements (i.e., the descriptions related to FIGS. 3A to 4C) may: (1) have lowest position in frequency domain; or (2) be configured by the BS 102; or (3) have largest bandwidth; or (4) have lowest subband identification.

In some embodiments, based on the associations between the at least one subband and the first BWP above, there may be a plurality of subbands that can be associated with the first BWP (i.e., multiple subbands can be associated with the first BWP). In some cases, the subbands fulfilling the above requirements (i.e., the descriptions related to FIGS. 3A to 4C) may be associated the first BWP. In some cases, which subbands are associated with the first BWP may be configured by the BS 102. In some cases, when a first subband is associated with the first BWP and the first subband contains a second subband, the second subband may be determined as disassociated with the first BWP.

In some embodiments, when there are multiple subbands associated with the first BWP, the subbands may be ordered with the following purposes: (1) facilitating to configure which subband(s) is (are) associated with the first BWP; or (2) indicating the schedule of subband(s) for physical uplink control channel (PUCCH) and physical uplink shared channel (PUSCH).

In some cases, the subbands may be ordered based on frequency domain positions of the subbands (e.g., ordering from lower frequency to higher frequency). In some cases, the subbands may be ordered based on a configuration from the BS 102. In some cases, when the subbands are configured separately from the configuration of the first BWP, each subband may be configured with an ID. Accordingly, the subbands may be ordered based on the IDs of the subbands.

It should be noted that, the orders of the subband for PUSCH and PUCCH may be the same or different. In some cases, the orders for both PUSCH and PUCCH are the same, and all the associated subbands are ordered for PUCCH and PUSCH. In some cases, the orders for PUCCH and PUSCH are different. For PUSCH, all the associated subbands are ordered. For PUCCH, only the subbands configured with PUCCH resources are ordered.

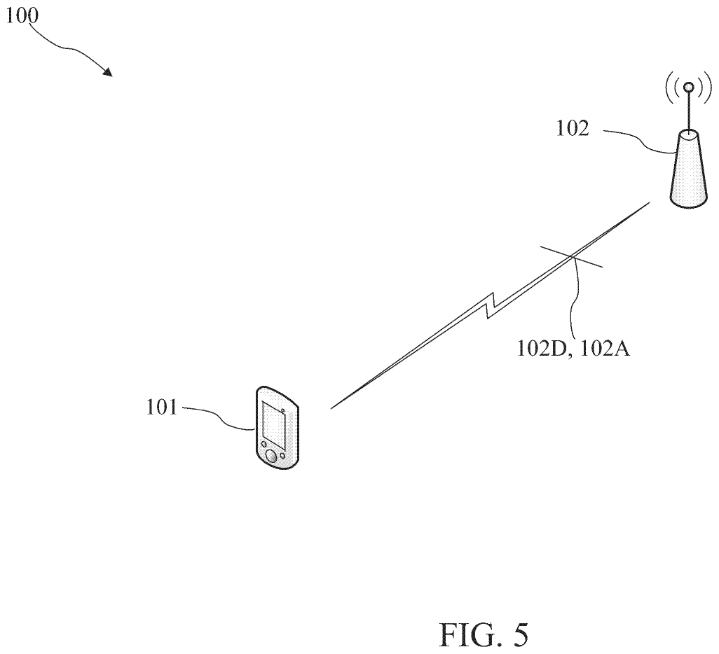

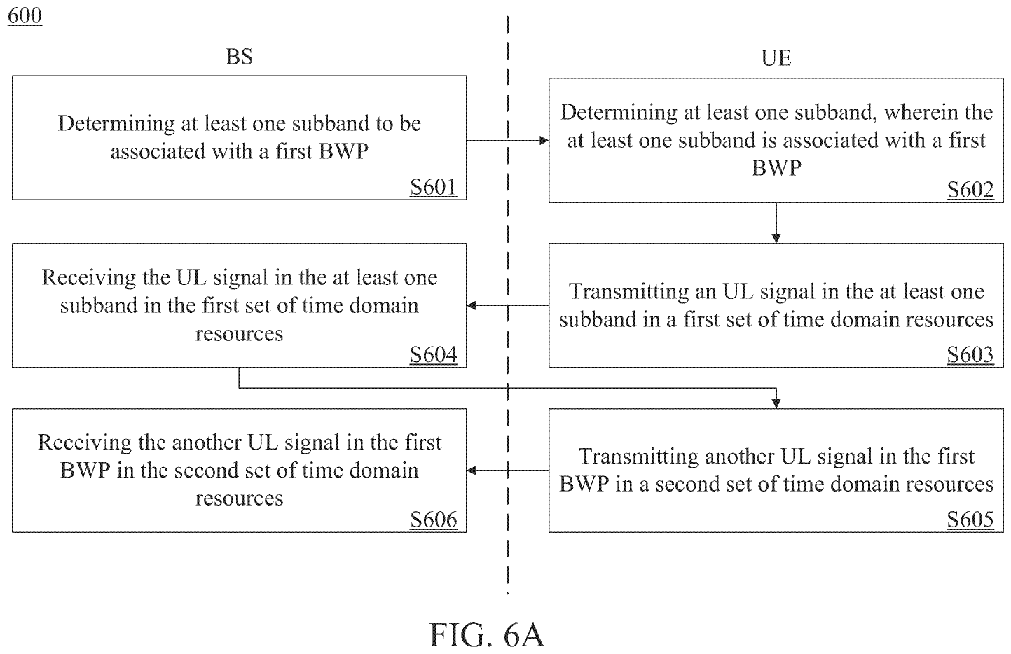

FIG. 5 is a schematic diagram of message transmission in accordance with some embodiments of the present application. In some embodiments, the BS 102 may transmit a subband indication 102A to the UE 101. The UE 101 may receive the subband indication 102A from the BS 102. The subband indication 102A may be included in a downlink control information (DCI) 102D of scheduling PUSCH. In some cases, the subband indication 102A may indicate the UE 101 to transmit PUSCH in at least one specific subband of the associated subband(s). In some cases, the DCI 102D may include a resource allocation in the first BWP, and resources allocated in the resource allocation are mapped to the associated subband(s). The resource mapping includes a resource indicated in the first BWP maps to a resource in an associated subband based on a predefined principle, e.g., if the resources indicated in the first BWP is not within the BW of any associated subbands, the resources outside of the subbands are not used for UL transmission. In some cases, the DCI 102D of scheduling PDSCH may include resource indication for PUCCH hybrid automatic repeat request acknowledgement (HARQ-ACK) feedback, and the subband indication 102A in the DCI may indicate the UE 101 to transmit PUCCH in at least one specific subband of the associated subband(s).

In some embodiments, PUCCH resource set(s) may be configured for the associated subband(s), and PUCCH resources of each PUCCH resource set may be unified ordered. Therefore, it may be not necessary to include any subband indication in the DCI 102D. More specifically, for the PUCCH resource sets of each associated subband with a same PUCCH resource set ID, the PUCCH resources may be ordered in increasing order of subbands. For example, if ‘m’ PUCCH resources of a PUCCH resource set ‘T’ is configured for the associated subband #0, and ‘n’ PUCCH resources of the PUCCH resource set ‘T’ is configured for the second associated subband #1, the ordered PUCCH resources can be {0, 1, . . . , m−1} for subband #0, and {m, m+1, . . . , m+n−1} for subband #1. The UE 101 can be indicated with a subband of the ordered subbands, and from the unified ordering, the UE 101 could know the subband and the PUCCH resource for transmitting PUCCH.

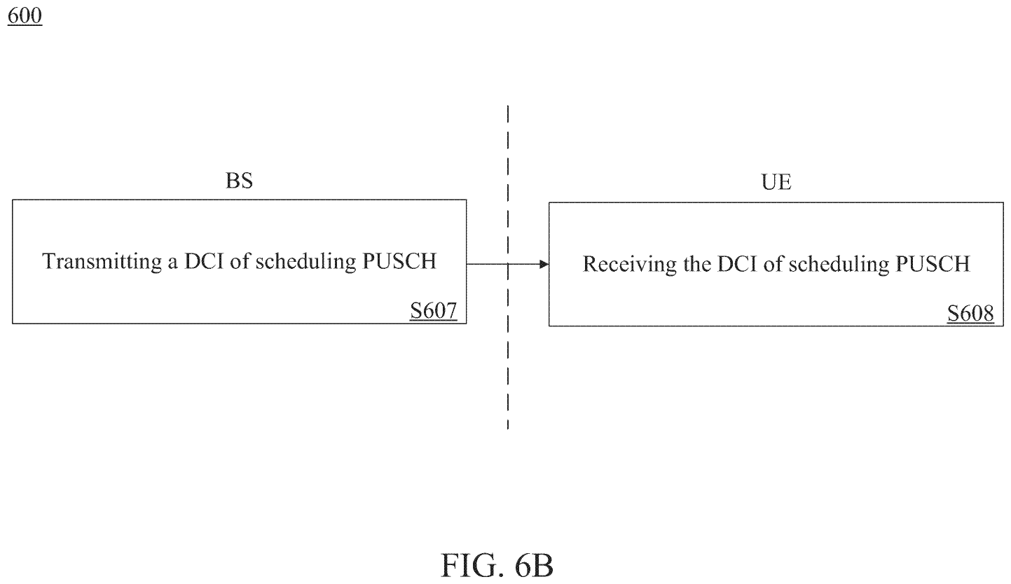

FIGS. 6A and 6B illustrate flow charts of a method for wireless communications in accordance with some embodiments of the present application. Referring to FIGS. 6A and 6B, method 600 is performed by a UE and a BS (e.g., the UE 101 and the BS 102) in some embodiments of the present application.

In some embodiments, operation S601 is executed to determine, by the BS, at least one subband to be associated with a first BWP for a specific UE. The BS may indicate the UE of the association. Operation S602 is executed to determine, by the UE, the at least one subband which is associated with the first BWP. Operation S603 is executed to transmit, by the UE, an UL signal in the at least one subband in a first set of time domain resources. Operation S604 is executed to receive, by the BS, the UL signal in the at least one subband in the first set of time domain resources. Operation S605 is executed to transmit, by the UE, another UL signal in the first BWP in a second set of time domain resources. Operation S606 is executed to receive, by the BS, the another UL signal in the first BWP in the second set of time domain resources.

In some embodiments, the at least one subband may be associated with the first BWP when: (1) the at least one subband is configured in a configuration of the first BWP; (2) the at least one subband is configured in a configuration of another BWP and is fully or partially within a bandwidth of the first BWP; or (3) the at least one subband is configured in a configuration of another BWP and a span of the at least one subband and the first BWP is within a bandwidth of a downlink BWP while the first BWP and the downlink BWP have the same BWP identification.

In some embodiments, the at least one subband may be configured separately from the configuration of the first BWP and the at least one subband may be associated with the first BWP when: (1) the at least one subband is fully or partially within a bandwidth of the first BWP; or (2) the span of the at least one subband and the first BWP is within the bandwidth of the downlink BWP, while the first BWP and the downlink BWP have the same BWP identification.

In some embodiments, the at least one subband may be associated with the first BWP when the numerology of the at least one subband is the same as a numerology of the first BWP.

In some embodiments, there may be a single subband associated with the first BWP (i.e., only one subband can be associated with the first BWP), and the single subband may: (1) be configured in the configuration of the first BWP; or (2) have lowest position in frequency domain when the at least one subband is not configured in the configuration of the first BWP; or (3) be configured by a BS when the at least one subband is not configured in the configuration of the first BWP; or (4) have largest bandwidth when the at least one subband is not configured in the configuration of the first BWP; or (5) have lowest subband identification when the at least one subband is not configured in the configuration of the first BWP.

In some embodiments, the at least one subband associated with the first BWP may include a plurality of subbands. The subbands may have at least one specific subband configured in the configuration of the first BWP and rest of subband configured by the BS. In some embodiments, the at least one subband associated with the first BWP may include a first subband containing a second subband and the second subband may be determined as disassociated with the first BWP.

In some embodiments, the plurality of subbands associated with the first BWP may be ordered for PUSCH or PUCCH. In some cases, the subbands may be ordered based on frequency domain positions of the subbands (e.g., ordering from lower frequency to higher frequency). In some cases, the subbands may be ordered based on a configuration from the BS. In some cases, when the subbands are configured separately from the configuration of the first BWP, each subband may be configured with an ID. Accordingly, the subbands may be ordered based on the IDs of the subbands.

In some embodiments, operation S607 is executed to transmit, by the BS, a DCI scheduling PUSCH. Operation S608 is executed to receive, by the UE, the DCI of scheduling PUSCH. In some cases, the DCI may include a subband indication indicating the UE to transmit PUSCH in at least one specific subband. In some cases, the DCI may include a resource allocation in the first BWP, and resources allocated in the resource allocation are mapped to the at least one subband. In some cases, the DCI may be for PUCCH HARQ-ACK feedback and may include a subband indication indicating the UE to transmit PUSCH in at least one specific subband.

In some embodiments, PUCCH resource set(s) may be configured for the associated subband(s), and PUCCH resources of each PUCCH resource set may be unified ordered. Therefore, it may be not necessary to include any subband indication in the DCI 102D. More specifically, for the PUCCH resource sets of each associated subband with a same PUCCH resource set ID, the PUCCH resources may be ordered in increasing order of subbands.

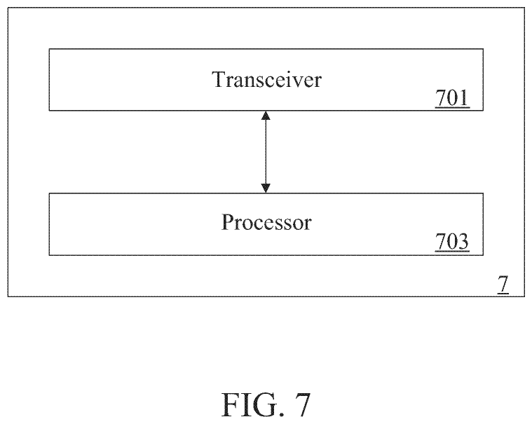

FIG. 7 illustrates an example block diagram of an apparatus 7 according to an embodiment of the present disclosure.

As shown in FIG. 7, the apparatus 7 may include at least one non-transitory computer-readable medium (not illustrated in FIG. 7), a transceiver 701 and a processor 703 electrically coupled to the non-transitory computer-readable medium (not illustrated in FIG. 7) and the transceiver 701. The apparatus 7 may be a UE or a BS.

Although in this figure, elements such as processor 703 and transceiver 701 are described in the singular, the plural is contemplated unless limitation to the singular is explicitly stated. In some embodiments of the present disclosure, the transceiver 701 may be separated into to circuitry, such as a receiving circuitry and a transmitting circuitry. In certain embodiments of the present disclosure, the apparatus 7 may further include an input device, a memory, and/or other components.

In some embodiments of the present disclosure, the non-transitory computer-readable medium may have stored thereon computer-executable instructions to cause a processor to implement the method with respect to the user equipment as described above. For example, the computer-executable instructions, when executed, cause the processor 703 interacting with the transceiver 701, so as to perform the operations with respect to the UE depicted in the figures.

Those having ordinary skill in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes”, “including”, or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a”, “an”, or the like does not, without more constraints, preclude the existence of additional identical elements in the process, method, article, or apparatus that includes the element. Also, the term “another” is defined as at least a second or more. The term “having” and the like, as used herein, are defined as “including”.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

What is claimed is:

1. A user equipment (UE), comprising:
at least one memory; and
at least one processor coupled with the at least one memory and configured to cause the UE to:
determine at least one subband, wherein the at least one subband is associated with a first bandwidth part (BWP); and
transmit an uplink signal in the at least one subband in a first set of time domain resources.

2. The UE of claim 1, wherein the at least one processor is further configured to cause the UE to:
transmit another uplink signal in the first BWP in a second set of time domain resources.

3. The UE of claim 1, wherein the at least one subband is associated with the first BWP based at least in part on at least one of:
the at least one subband is configured in a configuration of the first BWP;
the at least one subband is configured in a configuration of another BWP configuration and is fully or partially within a bandwidth of the first BWP; or
the at least one subband is configured in a configuration of another BWP and a span of the at least one subband and the first BWP is within a bandwidth of a downlink BWP, wherein the first BWP and the downlink BWP have a same BWP identification.

4. The UE of claim 1, wherein the at least one subband is associated with the first BWP based at least in part on at least one of:
the at least one subband is configured separately from a configuration of the first BWP, and the at least one subband is fully or partially within a bandwidth of the first BWP; or
a span of the at least one subband and the first BWP is within a bandwidth of a downlink BWP, wherein the first BWP and the downlink BWP have a same BWP identification.

5. The UE of claim 1, wherein the at least one subband is associated with the first BWP when a numerology of the at least one subband is same as a numerology of the first BWP.

6. The UE of claim 1, wherein the at least one subband associated with the first BWP includes a single subband which is one or more of:
configured in a configuration of the first BWP;
lowest position in frequency domain when the at least one subband is not configured in the configuration of the first BWP;
configured by a base station when the at least one subband is not configured in the configuration of the first BWP;
largest bandwidth when the at least one subband is not configured in the configuration of the first BWP; or
lowest subband identification when the at least one subband is not configured in the configuration of the first BWP.

7. The UE of claim 1, wherein the at least one subband associated with the first BWP includes a plurality of subbands which has at least one specific subband configured in a configuration of the first BWP, and remaining subbands configured by a base station.

8. The UE of claim 1, wherein the at least one subband associated with the first BWP includes a first subband containing a second subband and the second subband is determined as disassociated with the first BWP.

9. The UE of claim 1, wherein the at least one subband associated with the first BWP includes a plurality of subbands, and the subbands are ordered for physical uplink shared channel (PUSCH) or physical uplink control channel (PUCCH).

10. The UE of claim 9, wherein the subbands are order based on one or more of:
frequency domain positions of the subbands;
a base station configuration; or
identifications of the subbands.

11. The UE of claim 1, wherein the at least one processor is further configured to cause the UE to:
receive a downlink control information (DCI) of scheduling physical uplink shared channel (PUSCH), wherein the DCI includes a subband indication indicating the UE to transmit PUSCH in at least one specific subband.

12. The UE of claim 1, wherein the at least one processor is further configured to cause the UE to:
receive a downlink control information (DCI) of scheduling physical uplink shared channel (PUSCH), wherein the DCI includes a resource allocation in the first BWP, and resources allocated in the resource allocation are mapped to the at least one subband.

13. The UE of claim 1, wherein the at least one processor is further configured to cause the UE to:
receive a downlink control information (DCI) scheduling physical uplink shared channel (PUSCH) for physical uplink control channel (PUCCH) hybrid automatic repeat request acknowledgement (HARQ-ACK) feedback, wherein the DCI includes a subband indication indicating the UE to transmit PUCCH in at least one specific subband.

14. The UE of claim 1, wherein at least one physical uplink control channel (PUCCH) resource set is configured for the at least one subband, and PUCCH resources of each PUCCH resource set is unified ordered.

15. A method of a user equipment (UE), comprising:
determining, by the UE, at least one subband, wherein the at least one subband is associated with a first bandwidth part (BWP); and
transmitting, by the UE, an uplink signal in the at least one subband in a first set of time domain resources.

16-28. (canceled)

29. A base station (BS), comprising:
at least one memory; and
at least one processor coupled with the at least one memory and configured to cause the base station to:
determine at least one subband, wherein the at least one subband is associated with a first bandwidth part (BWP); and
receive an uplink signal from a user equipment (UE) in the at least one subband in a first set of time domain resources, wherein the at least one subband is associated with the first BWP.

30-32. (canceled)

33. A processor for wireless communication, comprising:
at least one controller coupled with at least one memory and configured to cause the processor to:
determine at least one subband, wherein the at least one subband is associated with a first bandwidth part (BWP); and
transmit an uplink signal in the at least one subband in a first set of time domain resources.

34. The processor of claim 33, wherein the at least one controller is configured to cause the processor to transmit another uplink signal in the first BWP in a second set of time domain resources.

35. The processor of claim 33, wherein the at least one subband is associated with the first BWP based at least in part on at least one of:
the at least one subband is configured in a configuration of the first BWP;
the at least one subband is configured in a configuration of another BWP configuration and is fully or partially within a bandwidth of the first BWP; or
the at least one subband is configured in a configuration of another BWP and a span of the at least one subband and the first BWP is within a bandwidth of a downlink BWP, wherein the first BWP and the downlink BWP have a same BWP identification.

36. The processor of claim 33, wherein the at least one subband is associated with the first BWP based at least in part on at least one of:
the at least one subband is configured separately from a configuration of the first BWP, and the at least one subband is fully or partially within a bandwidth of the first BWP; or
a span of the at least one subband and the first BWP is within a bandwidth of a downlink BWP, wherein the first BWP and the downlink BWP have a same BWP identification.
